(19) United States
(12) Patent Application Publication
(10) Pub. No.: US 2020/0163157 A1
(43) Pub. Date: May 21, 2020

(54) SYSTEMS AND METHODS FOR MANAGING HYPER-LOCALIZED COMMUNICATION NETWORKS

(71) Applicants: Sarthak S. Sawarkar, Lawrence Township, NJ (US); Ankit Srivastava, Brewster, NY (US); Amit Degavekar, Lawrence Township, NJ (US); Sudha Haran, Lawrence Township, NJ (US)

(72) Inventors: Sarthak S. Sawarkar, Lawrence Township, NJ (US); Ankit Srivastava, Brewster, NY (US); Amit Degavekar, Lawrence Township, NJ (US); Sudha Haran, Lawrence Township, NJ (US)

(21) Appl. No.: 16/685,325

(22) Filed: Nov. 15, 2019

Related U.S. Application Data
(60) Provisional application No. 62/770,438, filed on Nov. 21, 2018.

(51) Int. Cl. H04W 88/06; H04W 4/029; H04L 29/08; H04W 64/00; H04W 84/12

(52) U.S. Cl. CPC H04W 88/06; H04W 4/029; H04L 67/1085; H04W 64/003; H04W 84/12; H04L 67/18

(57) ABSTRACT

According to various embodiments, a communication system can be configured to build gated or secured networks that require physical presence to interact on the respective communication network. In some embodiments, these secured networks are associated with a real world or physical location, such that a user must be within or proximate to the real world or physical location in order to access communication taking place on the secured network. In further embodiments, the system can manage any number of such networks simultaneously. In some examples, users are allowed to create their own secured network and associate their network with a specific location or location boundary.

### RELATED APPLICATIONS

This application claims priority under 35 U.S.C. § 119(e) to U.S. Provisional Application Ser. No. 62/770,438 entitled “SYSTEMS AND METHODS FOR MANAGING HYPER-LOCALIZED COMMUNICATION NETWORKS,” filed on Nov. 21, 2018, which application is incorporated herein by reference in its entirety.

### BACKGROUND

Various conventional systems exist that provide instant and interactive communication between users of various computing devices. A problem that frequently plagues such conventional systems is the overload of messages, communication options, and a disconnection from the real world or physical location.

### SUMMARY

The inventors have realized that some conventional communication systems can be improved to include physical communication boundaries implemented in conjunction with communication channels. According to various embodiments, a communication system can be configured to build gated or secured networks that require physical presence to interact on the respective communication network. In some embodiments, these secured networks are associated with a real world or physical location, such that a user must be within or proximate to the real world or physical location in order to access communication taking place on the secured network. In further embodiments, the system can manage any number of such networks simultaneously. In some examples, users are allowed to create their own secured network and associate their network with a specific location or location boundary.

According to one example, various privately created networks might overlap other privately created networks or system created networks. According to some embodiments, layering of communication networks can be managed by the system and each with respective access controls. In further examples, privately created doors may be visualized by the system response to completing a sign up account, or other option.

According to another example, the system can manage various secured networks based on location and specific events or time periods. A network may exist that is linked to an arena location and to a specific event occurring there. The network is available to users proximate or present in the venue leading up to and until the conclusion of the event or some threshold time after the event—at which time the secure network ceases, and potentially to be replaced by another virtual network associated with the venue and a new event.

According to various aspects, the communication system executes localization filtering to limit participants communicating on a network. Once allowed access the various users can communicate within the network in a general messaging space. User can post new threads or review existing thread. In addition, the system provides a localized messaging area even within the local network. User can transition to a focused communication session between one or more users by access a specific general thread. In some embodiments, once these focused communication channels are opened, the limitations on proximity may no longer be enforced on the network.

According to one embodiment, localized communication on the system can be used to facilitate face to face meeting of anonymous users, even exchange functionality can be managed on the system to preserve anonymity. In some examples, the system's API preserves an audit trail for payments executed on the system but does not break the anonymity of the exchanging users.

According to another aspect, external entities can leverage localized networks to deliver communications to specific user populations, that are known to be within or frequent a certain location based on their access to the localized networks. According to one example, commercial entities can be given permission to post messages to users within a local network. Alternatively, commercial entities can build hyper local offers that require specific degrees of proximity, temporality, and/or any other requirement that the commercial entities requests and/or specifies.

According to one aspect, a communication system for managing hyper-local communication boundaries and associated communications is provided. The system comprises at least one processor operatively connected to a memory, a positioning component, executed by the at least one processor, configured to establish positioning for a communication device associated with a user, a network boundary component, executed by the at least one processor, configured to define a plurality of communication boundaries having a respective physical location for respective ones of a plurality of communication networks, a communication controller component, executed by the at least one processor, configured to establish an association between a device location and at least a respective one of the plurality of communication boundaries, permit access to a hyper-local communication network responsive to a determining a communication device is within or proximate to the respective one of the plurality of communication boundaries, and prevent access to the hyper-local communication network responsive to determining the communication device is outside of or not proximate to the respective one of the plurality of communication boundaries.

According to one embodiment, the system further comprises a dynamic communication interface configured to display a user interface on a respective device, wherein the UI dynamically adjusts communication functions and displays based on permitted access to respective ones of the hyper-local communication networks. According to one embodiment, the network boundary component is further configured to establish a respective physical boundary for a communication network based on a location of a venue or institution. According to one embodiment, the network boundary component is further configured to establish a temporary network and associated the temporary network with a virtual location associated with a physical location and future event to take place at the physical location. According to one embodiment, the network boundary component is further configured to establish a new communication network dynamically, responsive to a user request and user definition of a communication boundary. According to one embodiment, the system further comprises a validation component, executed by the at least one processor, configured to validate users for access to the hyper-local communication network. According to one embodiment, the communication boundaries include at least one static boundary defining a first hyper-local network and at least one dynamically generated communication boundary defining a second hyper-local network.

According to one aspect, a computer implemented method for managing local communication boundaries and associated networks is provided. The method comprises establishing, by at least one processor, positioning for a communication device associated with a user, defining, by the at least one processor, a plurality of communication boundaries having a respective physical location for respective ones of a plurality of communication networks, generating, by the at least one processor, an association between a device location and at least a respective one of the plurality of communication boundaries, permitting, by the at least one processor, access to a localize communication network responsive to a determining a communication device is within or proximate to the respective one of the plurality of communication boundaries, and preventing, by the at least one processor, access to the local communication network responsive to determining the communication device is outside of or not proximate to the respective one of the plurality of communication boundaries.

According to one embodiment, the method further comprises to displaying a user interface on a respective device, wherein the UI is configured to dynamically adjust communication functions and displays based on permitted access to respective ones of the hyper-local communication networks. According to one embodiment, the method further comprises establishing a respective physical boundary for a respective communication network based on a location of a venue or institution. According to one embodiment, the method further comprises establishing a temporary network and associated the temporary network with a virtual location and future event. According to one embodiment, the method further comprises establishing a new communication network dynamically, responsive to a user request. According to one embodiment, the method further comprises validating users for access to a respective local communication network. According to one embodiment, the method further comprises defining a first local network with a static communication boundary and at least one dynamically generated communication boundary defining a second local network.

According to one aspect, a non-transitory computer readable medium containing instructions that when executed cause at least one processor to execute a computer implemented method for managing local communication boundaries and associated networks is provided. The method comprises establishing positioning for a communication device associated with a user, defining a plurality of communication boundaries having a respective physical location for respective ones of a plurality of communication networks, generating an association between a device location and at least a respective one of the plurality of communication boundaries, permitting access to a localize communication network responsive to a determining a communication device is within or proximate to the respective one of the plurality of communication boundaries, and preventing access to the local communication network responsive to determining the communication device is outside of or not proximate to the respective one of the plurality of communication boundaries.

According to one embodiment, the method further comprises displaying a user interface on a respective device, wherein the UI is configured to dynamically adjust communication functions and displays based on permitted access to respective ones of the hyper-local communication networks. According to one embodiment, the method further comprises establishing a respective physical boundary for a respective communication network based on a location of a venue or institution. According to one embodiment, the method further comprises establishing a temporary network and associated the temporary network with a virtual location and future event. According to one embodiment, the method further comprises establishing a new communication network dynamically, responsive to a user request. According to one embodiment, the method further comprises validating users for access to a respective local communication network.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE FIGURES

Various aspects of at least one embodiment are discussed below with reference to the accompanying Figures, which are not intended to be drawn to scale. Where technical features in the Figures, detailed description or any claim are followed by reference signs, the reference signs have been included for the sole purpose of increasing the intelligibility of the Figures, detailed description, and claims. Accordingly, neither the reference signs nor their absence is intended to have any limiting effect on the scope of any claim elements. In the Figures, each identical or nearly identical component that is illustrated in various Figures is represented by a like numeral. For purposes of clarity, not every component may be labeled in every Figure. The Figures are provided for the purposes of illustration and explanation and are not intended as a definition of the limits of the invention. In the Figures:

FIG. 1 is a block diagram of an example communication system, according to one embodiment;

FIG. 2 is an example process flow for managing communication, according to one embodiment;

FIG. 3 is an example special purpose computer system that can execute various functionality discussed herein to improve over conventional implementation;

FIG. 4 is an example user interface, according to one embodiment;

FIG. 5 is an example user interface, according to one embodiment;

FIG. 6 is an example user interface, according to one embodiment;

FIG. 7 is an example user interface, according to one embodiment;

FIG. 8 is an example user interface, according to one embodiment;

FIG. 9 is an example user interface, according to one embodiment;

FIG. 10 is an example user interface, according to one embodiment;

FIG. 11 is an example user interface, according to one embodiment;

FIG. 12 is a block diagram of an example environment, according to one embodiment;

FIG. 13 is a block diagram of an example environment, according to one embodiment;

FIG. 14 is an example user interface, according to one embodiment;

FIG. 15 is an example user interface, according to one embodiment;

FIG. 16 is an example user interface, according to one embodiment;

FIG. 17 is an example user interface, according to one embodiment;

FIG. 18 is an example user interface, according to one embodiment;

FIG. 19 is an example user interface, according to one embodiment;

FIG. 20 is an example user interface, according to one embodiment;

FIG. 21 is an example user interface, according to one embodiment;

FIG. 22 is an example user interface, according to one embodiment;

FIG. 23 is an example process flow for accessing a hyper local network, and

FIG. 24 is an example process flow for defining limited communication offers, according to one embodiment.

### DETAILED DESCRIPTION

According to some aspects, a communication system is provided that manages a plurality of secure networks. According to one embodiment, the system generates and maintains the secure networks such that proximity is required to access the respective networks. Upon accessing the secure network, users can participate in a general messaging area (e.g., accessing or creating message threads, for example). Further, users can enter a private communication mode based on responding to specific users in general threads. In other aspects, commercial entities can leverage the existence of the communication networks and user populations within the networks to build and deliver highly focused communications to the user populations that can be focused in terms of location, time, and/or network activity. These “hyper-local” communications permit targeting and insight into user populations in a manner that conventional approaches cannot provide.

According to various embodiments, proximity or presence in a location enables users to execute a respective application to access a respective secured network. Access to the secured networks enables communication functionality in the application (e.g., access a general chat space), and enables users within the location to communicate with each other. In various embodiments, the application is configured to establish the anonymity of the respective users, providing anonymized identifiers in a global chat room shown in the application.

In some embodiments, the system can be configured to police anonymity. For example, monitoring chats for identifying information (e.g., user names on other sites, first/last name, etc.), and issue warnings regarding revealing personal information. In other embodiments, anonymity is not enforces, and in other not used. In some embodiments, the system can manage verified communication threads, wherein users are required to reveal identities. Various combinations of communication threads that required verification of identity, can be controlled by the system in conjunction with other communication threads that provide options for anonymity.

The global chat display provides access to any existing message threads on the respective network, and allows user to create new messages threads, etc. In further embodiments, users access the message threads in the global or general messaging space to begin private or localized communication sessions between participating users. The transitions from general chat functionality to the localized sessions can alter the functionality of the messaging control. In one example, the limitation imposed on network access are no longer enforced once two or more users begin communicating in localized communication sessions. In one example, two users can trigger a communication session from the general messaging space, and continue the user-based messaging session even if one of the users leaves the location of the respective network. In one example, the system is configured to enable one user to decline/end chat and subsequently the other user will not be able to reach out to the user who declined/ended the chat.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

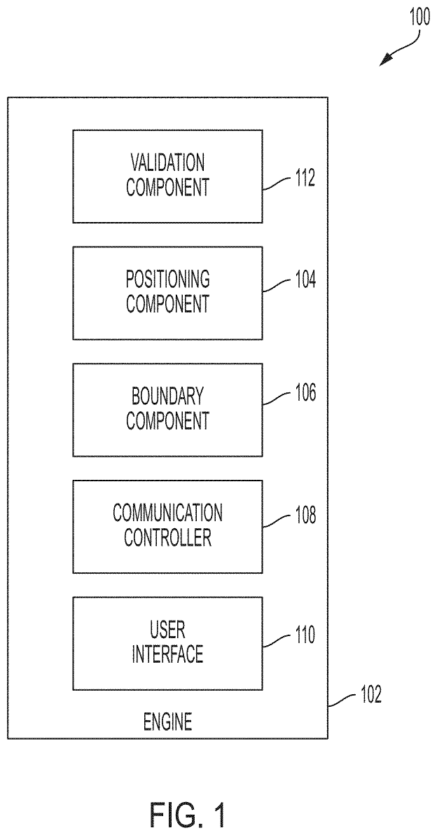

FIG. 1 is a block diagram of an example communication system 100. The communication system can include a communication engine 102 configured to manage construction, maintenance, and access to a plurality of secure networks. In some embodiments, the system 100 and/or engine 102 can instantiate a plurality of component to execute functionality of the communication system. In other embodiments, the system 100 can execute any of the functionality discussed with or without instantiating specific components.

According to some embodiments, the system and/or engine 102 can include a position component configured to determine a location of a user device (e.g., mobile phone, laptop, computer, etc.). The position component 104 is configured to establish a location of the user/device and allow the system to use the determined location to permit or deny access to respective secured networks.

In further embodiments, the system 100 and/or engine 102 can include a boundary component configured to define localization areas or to define approximate real world locations associated with respective secured communication networks. The boundary component can establish an area for a network and/or establish an area that a user must be proximate to in order to access or participate in the network.

In some embodiments, the system can use the information from the positioning component 104 and the boundary component 106 to enable access to a given network and/or network functionality. In one embodiment, the system 100 and/or engine 102 can include a communication controller 108 that is configured to limit access to secure networks based on location information. In some examples, the communication controller 108 is configured to determine that the conditions defined by the boundary component 106 are met based on position information from the positioning component 104. Responsive to a positive validation the communication controller can dynamically grant access to a specific network.

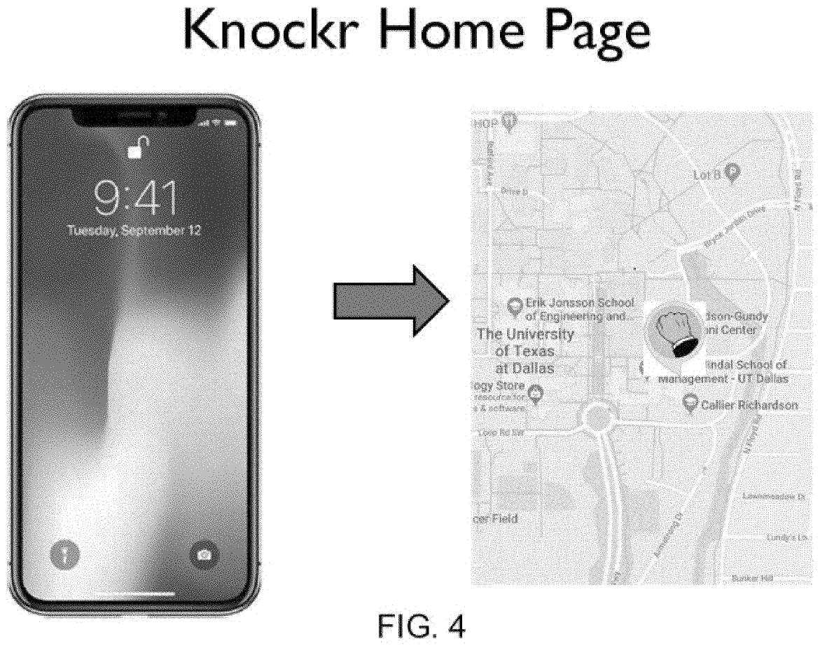

According to further embodiments, the system 100 and/or engine 102 can include user interface component 110. The user interface component can be configured to generate interaction displays associated with defined networks and respective boundaries. According to various examples, the user interface can include a positioning visualization to show proximate networks, and include functionality in the user interface to allow users to select a respective network and request access. In a further example, the user interface can also be configured to enable users to define location boundaries in a position visualization to establish their own networks and respective boundaries. In one example, the position visualization can include a map display with bounded areas representing secured networks highlighted in the display. The system is configured to allow users to request access to a respective network by selecting the network in the display. FIGS. 4-22 (discussed below) illustrate examples of implementation of a communication system, user interfaces, and communication functionality supported by the system.

In some embodiments, the communication system 100 and/or engine 102 can include additional components. For example, some embodiments can include a validation component 112 to validate user access to the system. As discussed above, user interaction and communication can be implemented to preserve anonymity (even as part of face-to-face interaction and exchange). Such anonymity can be detrimental to operation if there is no assurance that users are validated or verified to participate. In one example, the system is configured to determine that a user in valid based on location context. A network can be sited on or around a university location (e.g., class location, library, university coffee shop, etc.). The system can be configured to validate a user population for that location based on being an enrolled student or alumni. Validation can be made and/or enforced on the system on a network by network basis, such that a validated user in the university context would not be granted access in an unrelated location/network. In other embodiments, once a user is validated, that user is validated on the system and can access any secured network (e.g., once any other requirements are met). In yet other embodiments, a network creator can provide additional restriction upon creating the network, and mandate specific validation criteria as well as defining a location boundary for the secure network.

According to another aspect, the communication system can also function to limit access to certain data items based on proximity to a location, validation, and a continued presence at the location. For example, certain data items (e.g., referred to as “hyper-local” data items) can be created by users on the system such that only if specific requirements are met are users given access to the hyper-local data items. In one example, baseline requirements are managed automatically by the system (e.g., must be proximate or present in a location boundary of a network and/or specifically validated user). A hyper-local data item creator/generator can add additional requirements (e.g., must be present at a location boundary a threshold number of times, must be present at location for a threshold period of time, etc.). In this manner, a data item creator can ensure a significant connection to a location, area, or place exists before granting additional access. In one example, the data item can include specification of additional access within a location (e.g., VIP access instructions), can include communication of specific data items to users meeting the criteria, etc.

According to one embodiment, hyper-local offers can be tailored to specific locations (e.g., venue, sports arena, library, classroom, vendor, coffee shop, store, gym, etc.), and continued presence the location triggers the system to provide access to respective hyper-local offers or communicate the hyper-local offers directly. In further embodiments, such hyper-local offers can be limited in time to encourage action. In one example, the system can determine based on user position, a time for expiring the data item or associated action, based on a period of time determined that it will take a user to go from a current location to an area within the network boundary associated with the action.

Various other embodiments, can include additional components, including, for example, a separate network creation component, that enables registered and/or validated users to create new networks and respective location boundaries, and/or build hyper-local data items for distribution within secured networks. In one example, a creation component can enable visualizations in conjunction with the UI component (e.g., 110) for defining location boundaries for a new network, building hyper-local data etc., for communication or access within the network boundary, define a new location boundary within the network boundary of hyper-local data items, etc. Although specific functionality has been discussed with respect to specific components, various embodiments implement the specific functionality without resort to the specified components, rather the system can execute any of the functionalities, algorithms, options, and/or displays.

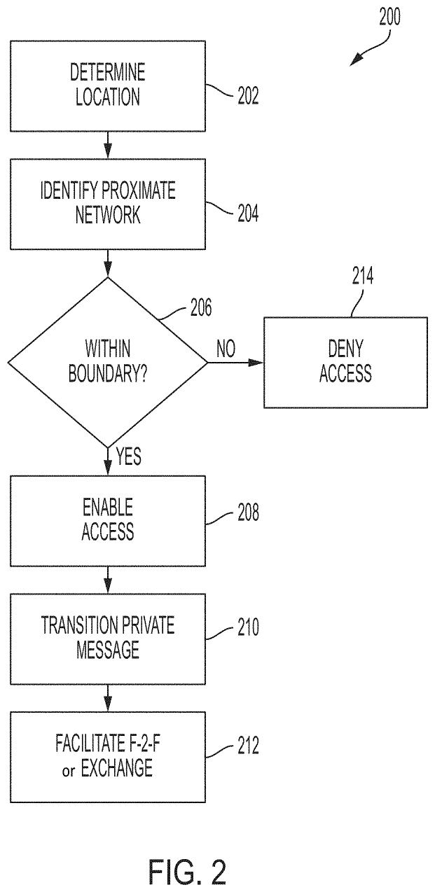

FIG. 2 is an example process 200 for managing communication. In various embodiments, process can be executed by a communication system (e.g., 100) to manage communication between users and/or apply localization filters to users' participation in various networks. In one example, process 200 can begin determining a user location at 202. Responsive to the determined user location, proximate secured networks can be identified at 204, and optionally shown in a user interface for the end user. In one example, proximate networks can be shown as doors or display elements that resemble doors in the user interface. A user application can be configured to present a knocking option (e.g., a request to enter the secure network (e.g., based on proximity)). If the user is determined to be within the boundary of the requested network 206 YES, then the user is given access to communication function on the respective network. For example, the user application can present a general messaging area in the application, and then allow the user to access general chat thread and/or initial private communication sessions with other users on the secured network. In one example, a user can access or create a new communication thread (e.g., once given access at 208). The user can then access private messaging functionality at 210 from the general communication area to communicate directly with other users. Optionally process 200 can include functionality to support face-to-face or physical exchange and/or payment at 212. In some examples, user can maintain their system based anonymity even where the users exchange payment for some item or service.

If it is determined at 206 that a user is not within a boundary or proximate to the boundary 206 NO, the user is denied access to the network and associated functionality (e.g., 214).

In further embodiments, process 200 can optionally include additional steps. For example, automatic translation can occur as part of process 200 for users attempting to communicate in different default languages, among other options. Alternatively, the process can analyze submitted communication determine a language and translate into a language for the recipient, and vice-versa.

Once users are present in a location or on a network, various embodiments provide additional access to those users as their presence meets a defined threshold (e.g., a time present threshold). In one example, the system can provide access to hyper-local functions or offers responsive to determining a user has met a threshold.

In other examples, representative users (e.g., businesses) can be given access to the system, and can be shown users to interact with based on any threshold established by that user. Thus in some examples, the system can facilitate delivery of hyper-local communication and/or access by the representative users to users having an established presence of some duration.

According to various aspects, the general messaging space and localization restriction departs from conventional communication implementation serves to improve communication speed and efficiency based on eliminating noise (e.g., un-focused, un-targeted, and/or generally not relevant communication). Removing such communication yields a more efficient series of networks and preserves bandwidth for relevant interaction.

According to another aspect, architecting communications to limit exchange between users based on a common location, operates as a filter on communicating users as well (and, for examples, improves network efficiency over conventional approaches). In further embodiments, localization filters increase the alignment between the users. The localization filtering can also be leveraged by the system to facilitate user interaction, including face to face meetings between users. Under system execution, users can remain anonymous while still facilitating face-to-face exchange. In yet other embodiments, localization filtering can also be used to tailor location specific and temporal based access. In one example, the initial localization filtering establishes a group present presence in a location. As one or more users remain in the location, additional options can become available (e.g., enhanced data access within the secure network, targeted communications, etc.).

In various embodiments, the system is configured to enable users to generate avatar icons to represent them in the user interface. In various examples, the avatars enable users to maintain anonymity while their presence within a location may be shown by an avatar.

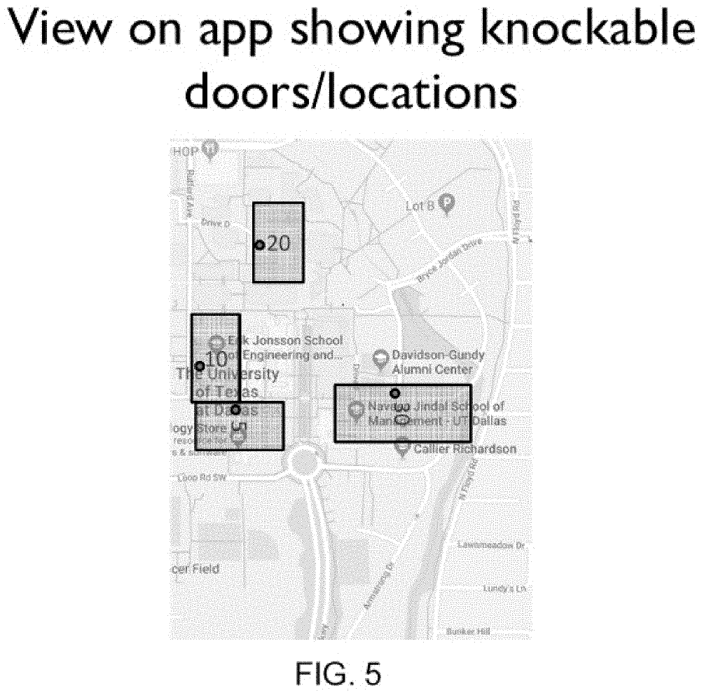

Shown in FIG. 4, is an example user interface which includes a localized communication network displayed on a map interface. In FIG. 5, shown, is an example user interface displaying networks on a map view. For example, FIG. 5 shows four “knockable” locations. Each location shown in FIG. 5 is a localized communication network where users who are within a certain distance or within a communication boundary can communicate with each other using the application in an localization exclusive communication network.

In some embodiments, the user actively knocks to enter a given network. For example, a double tap in the user interface on one of the displayed networks allows the user into the communication location. In further embodiments, visualizations of the networks (e.g., doors) are only shown in the UI or are only accessible in the UI if the user is within a certain distance or within a communication boundary defined for the network. According to further embodiments, locations shown within the user interface are configured to protect exact locations of the respective users. In one example, users may be shown within a network or door but the exact locations of those users within the communication network or communication boundary are randomized or skewed to prevent determination of position. In further example, once a user has entered a communication network (and been allowed entry where needed), that knockable location can remain as a greyed out visualization in the user's display, even if not proximate to the network.

According to another embodiment, the following example features can be used in any combination: 1) “Knockable Locations” a.k.a. “Doors” around them. (e.g., secure network); 2) A double tap on the doors triggers the system to permit knockers into the location; 3) Doors will be accessible (e.g., displayed or fully visualized, etc.) only if knockers are within the expected geolocation (e.g., within or proximate to a boundary); 4) Various examples are configured not to show exact location of other knockers (i.e., can be shown within communication network but actually physical location is not rendered or randomized).

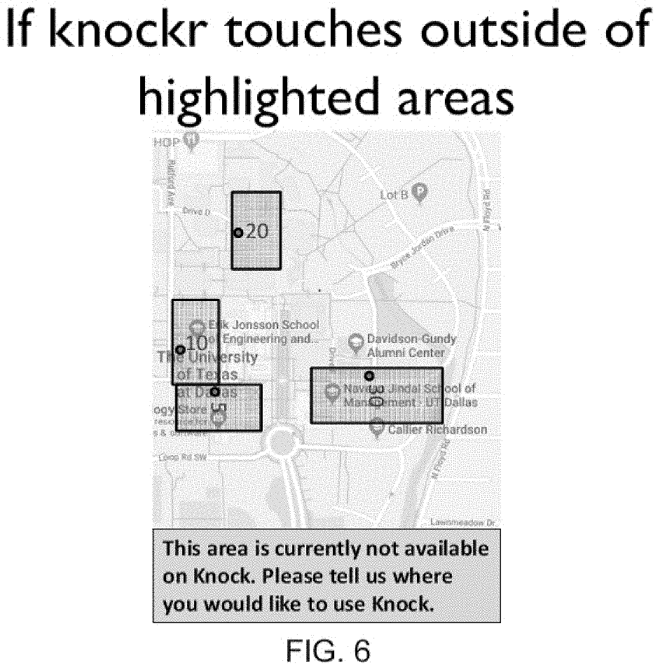

FIG. 6 shows another example interface. In various embodiments, the system can be configured to notify a user attempting to access a network that they cannot access. For example, proximate communication networks can be shown in the UI and a map display; however, the user may not be close enough to the respective networks to be permitted access. Upon selection of such a network, the system is configured to notify the user that they cannot access the respective network. In other embodiments, the system is configured to limit display of available networks to those that a user can access or is close enough to open or enter.

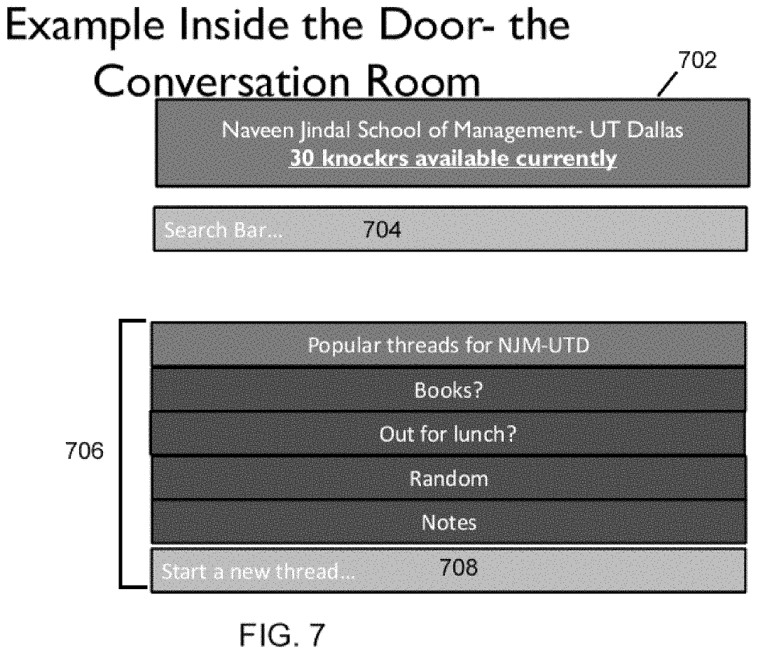

FIG. 7 shows example elements displayed in the user interface to users upon entry into a communication network. For example, each respective network has a name or door nameplate (e.g., 702). In one example, the interface will include a search bar (e.g., 704) that enables user-defined communication threads within a communication network or specific communications that have transpired.

According to another embodiment, the interface can include a display of the most popular threads within a communication network. For example, shown at 706 is a list of various popular threads ordered by their popularity. In a further example, any user entering the room can begin a new message thread (e.g., 708).

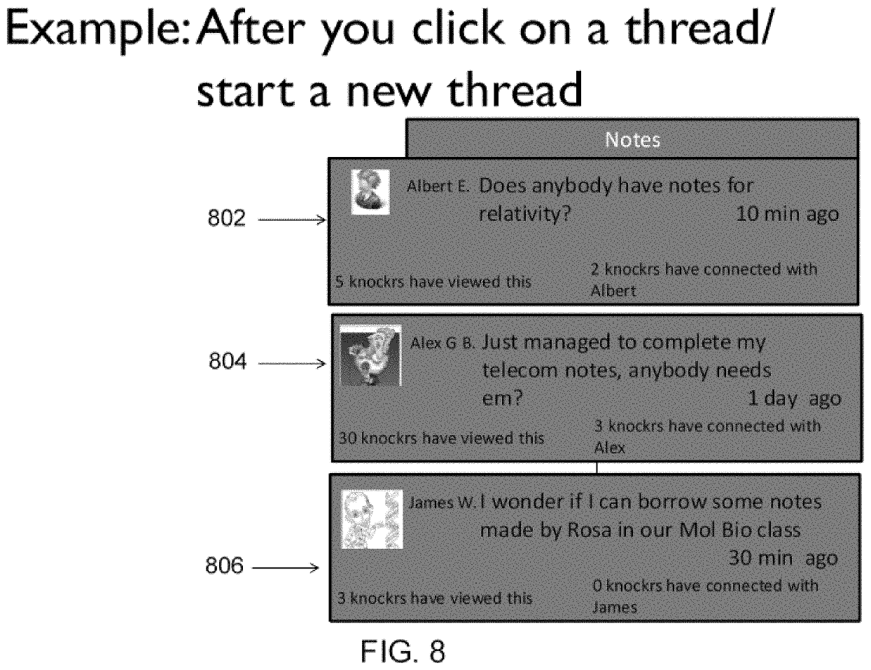

Shown in FIG. 8 are elements of a conversation between users. For example, at 802 a user can double tap on a conversation thread to enter the conversation—akin to knocking on the communication thread to participate. In further example, the interface can display popular topics with priority over others (e.g., 804). In another example, popular topics or conversations can be deprioritized or shown at lower position in the interface (e.g., at 806).

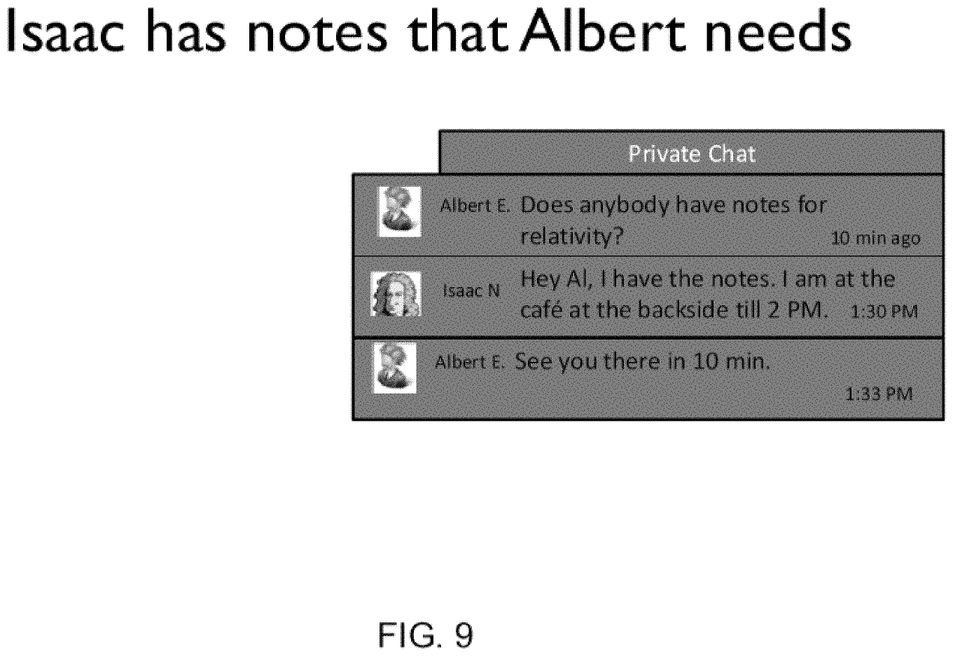

Shown in FIG. 9 is an example interface for managing a private chat between users. For example, in response to a user post or request another user can knock on the respective request and enter a private chat with the requestor.

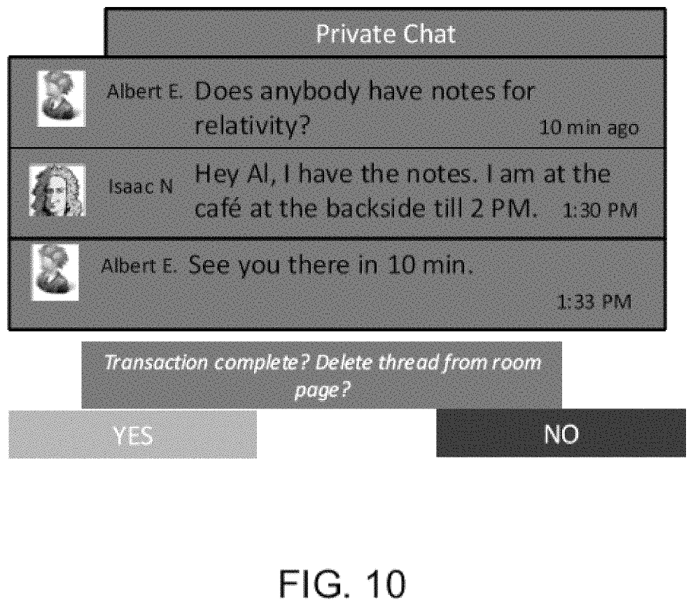

FIG. 10 illustrates functionality on the system for the originator of a requestor communication. For example, an open request to get notes for class can be answered by another user. Once the request has been completed the requestor can mark the transaction complete which will trigger the communication thread to be deleted. In some embodiments, the system will notify the user that marking the task complete will delete the corresponding message thread. In other examples, the system is configured to mark completed actions as in active, and can, in some examples, retain the communication chain or thread (e.g., for access by the requestor).

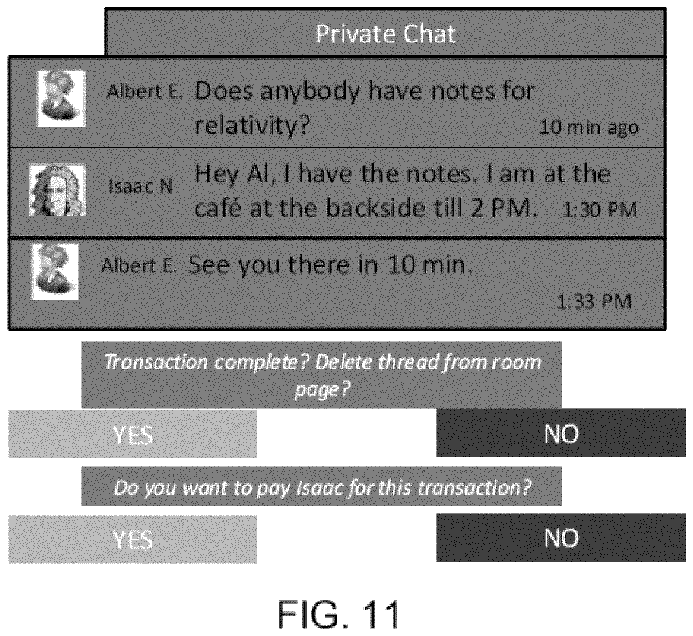

FIG. 11 illustrates additional functionality within the communication threads and/or communication network. For example, the communication threads can be integrated directly with payment gateways (e.g., VENMO, cryptocurrency platforms, or other payment service/gateways, among other options). In another example, the system can be configured to trigger payment functionality in response to an indication of a complete transaction or request.

In further embodiments, the system can provide additional functionality within the message threads or respective communication networks. In one example, the system is configured to provide auto translation capability. According to one embodiment, user profile information provides details on a native communication language for given user. The system can be configured to determine that a communication being accessed is not in a user's native communication language. In such examples, the system is configured to automatically translate the communication to the user's native language and provide an indication that the message is translated. In a further example, a user profile can specify multiple languages, and translation will only occur if a message is not one of those languages. In some multilingual examples, the profile for user can specify an order of preference for which language to use when auto translation is required.

In various settings, the system is configured to provide for hyper local offers for offers that are both proximate in time and space and other users. According to various embodiments, the system provides a platform for accessing local activities and services unavailable in conventional communication settings. Various environments and services can be specifically tailored for knockable locations and include in some examples, concerts, festivals, theater events, farmer's markets, among other options.

In a further example, the system enables users to establish dynamic radii for geolocation tailored to specific events, specific locations and/or specific user groups. In some examples, the system is further configured with machine learning models that can curate communication networks and/or communication feeds on behalf of the users, including in any of such settings.

In some implementations, the system manages virtual spaces where an event will take place. For example, a concert venue can be defined on the system as a virtual network prior to the concert starting. In this example, users are able to access conversations within the communication network (e.g. conversation corridors) in advance of the actual event. The location can cease to be a virtual space on the day of the event or approximate in time to the actual event occurring. According to some embodiments, virtual spaces may not have the same distance limitations for joining the virtual space as the communication network will have once the event starts. For example, the virtual location can cease to be a virtual location and proximity filters or requirements can be enforced once the virtual location is converted.

According to some embodiments, the system is configured to distribute hyper local offers to users in the area. For example, offers may be set up on the system with proximity requirements and temporal requirements such that a user detected to be located within a certain distance and for a certain period of time may be presented with specific offers. In addition, users may report such offers to other users on the system and provide information on what requirements may trigger such offers.

In further embodiments, hyper local offers can be tied to having been present on one or more of a plurality of communication networks. For example, a specific offer can include targeting requirements, where the system is configured to qualify one or more users to receive the specific offer only if they have entered and communicated in a local university communication network, the university book store, and a local coffee shop. In various embodiments, the system can be configured to associate such behaviors to target users and to track behavior of the user populations. The system can provide a variety of insights into user behavior that conventional system simply cannot achieve.

According to one embodiment, the system is also configured to provide review functionality in the context of private conversations. For example, in response to request that has been completed the request or can review the user who offered help or completed the task.

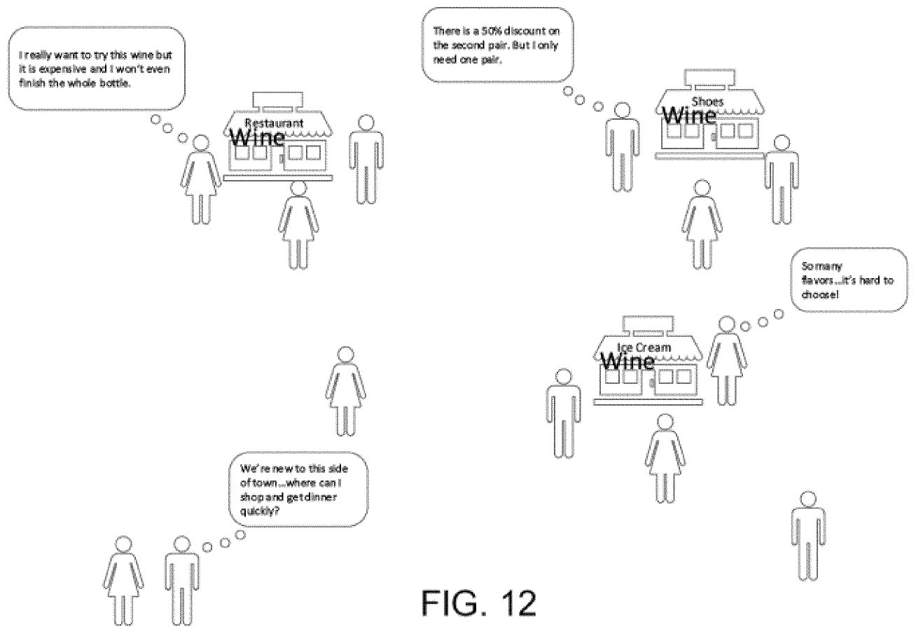

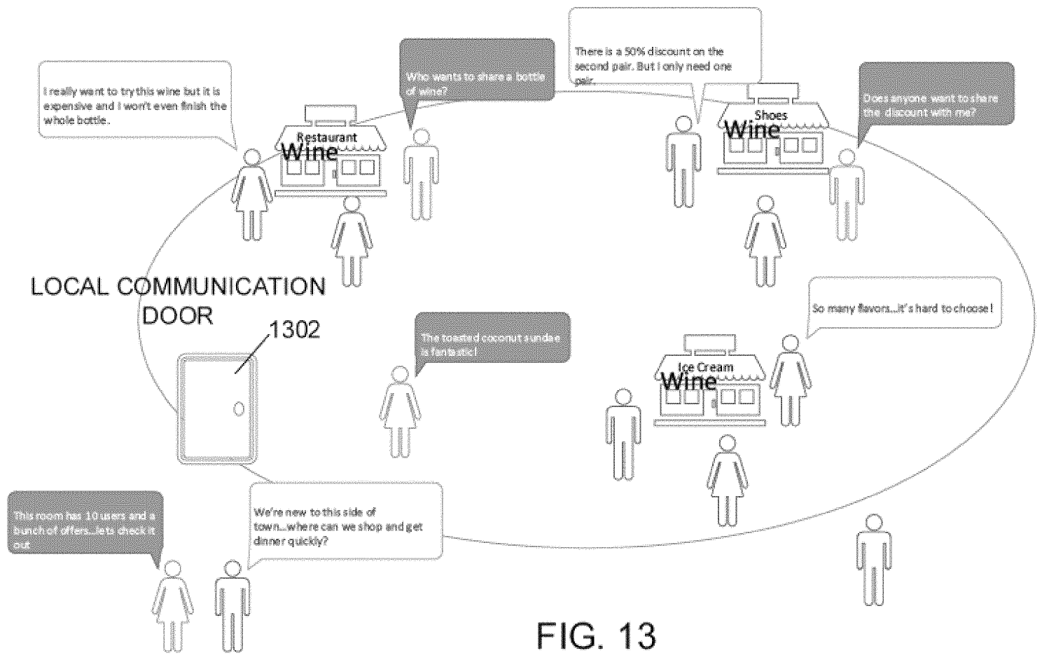

Shown in FIG. 12 is an example environment in which various embodiments of the system are particularly effective. For example, users in a specific area can interact with each other and resolve real-world needs once registered with the system. For example, FIG. 13 illustrates the questions and problems that individual users can resolve if they can connect to a localized community of other users. According to various aspects, the system solves this need with its novel communication architecture and implementation. For example, local communication door 1302 provides the gateway for the users to interact, share a discount, share a bottle of wine, and solicit advice, among other options. The local communication door 1302 illustrated in FIG. 13 can be made accessible via use of the system to access localized communication networks that are secure, private, and facilitate open exchange between proximate users.

According to various embodiments, the system is configured to facilitate a number of user scenarios and any number of use cases. For example, some compelling use cases include University settings, restaurants, airports, trade showing conventions, concerts and events, office settings, bars, residential complexes in neighborhoods, gyms, and tourist attractions, among other options.

According to one embodiment, the use case includes a user visiting a shoe store. Upon finding a pair of shoes the user likes the store offers the user a 50% discount on a second pair. In this example, the user only needs one pair of shoes and in a conventional setting, this results in a wasted opportunity. With the local communication system, however, the user can reach out to a local community, for example, within a communication network defined with the shoe store as a boundary. The local community can take advantage of the opportunity, and may even lead to compensation to the user.

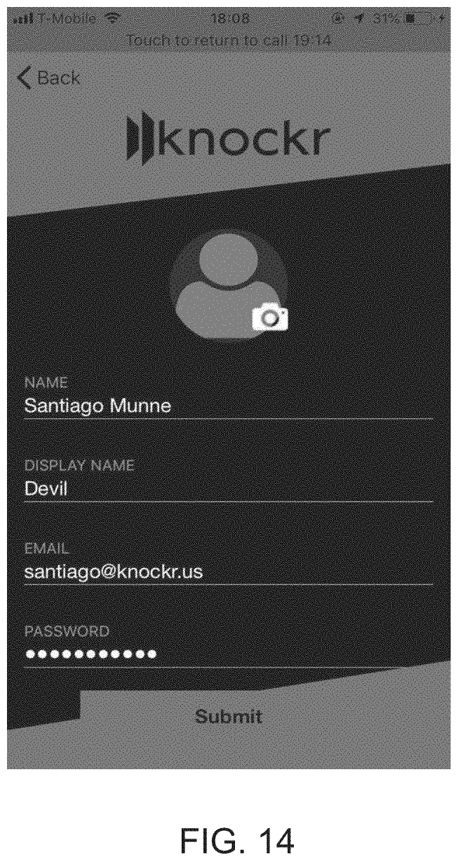

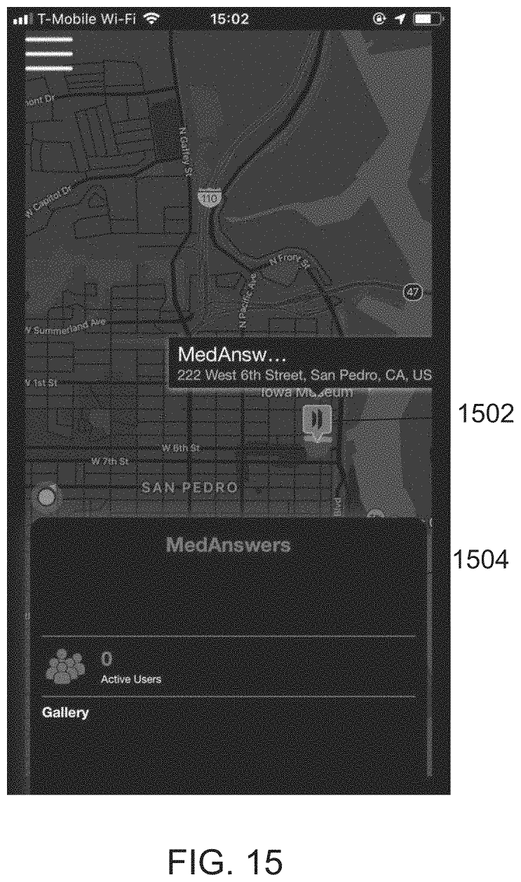

FIG. 14 illustrates an example of a user interface according to one embodiment. In FIG. 14 shown is an authentication window for accessing the system. Shown in FIG. 15 is an initial view displayed to the user once authenticated. According to one embodiment, the display will show local communication networks (e.g., 1502) that the user has or may access. For example, if the user has access to the network, the system is configured to display status information for activity within the network. In one example, this may include a display (e.g., 1504) of active users and/or a display of open questions to the community.

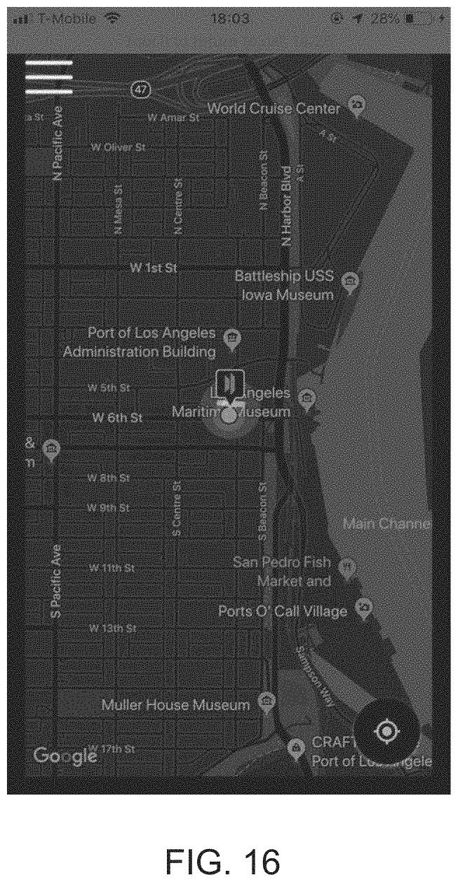

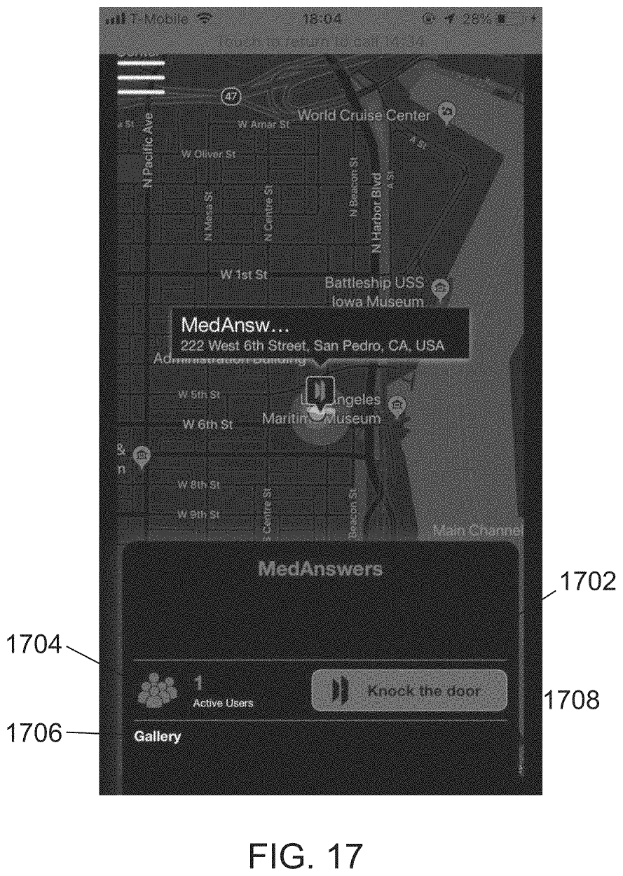

Shown in FIG. 16 is an example user interface displaying a zoomed out view of the map and local communication networks. For example, status displays can be transient and disappear from the screen after certain period of time or after certain period of time without activity. Shown in FIG. 17 is an example user interface where the user has hovered or selected one of the communication networks. In response to such selection or hover, the system is configured to display a status window at 1702. The status window may include a display of active users at 1704, and may include an image gallery at 1706. At 1708 the system provides an inter face element that upon selection will permit the user to enter the local communication network. In this example, the interface element includes the text “knock the door”. In this example, knock the door can be a request to access the local communication network. In some embodiments, the request must be approved before the user can enter and visualize content and/or communication threads within the local network. In other embodiments, the network can be open and request or selection of knock the door brings the user into the communication network immediately.

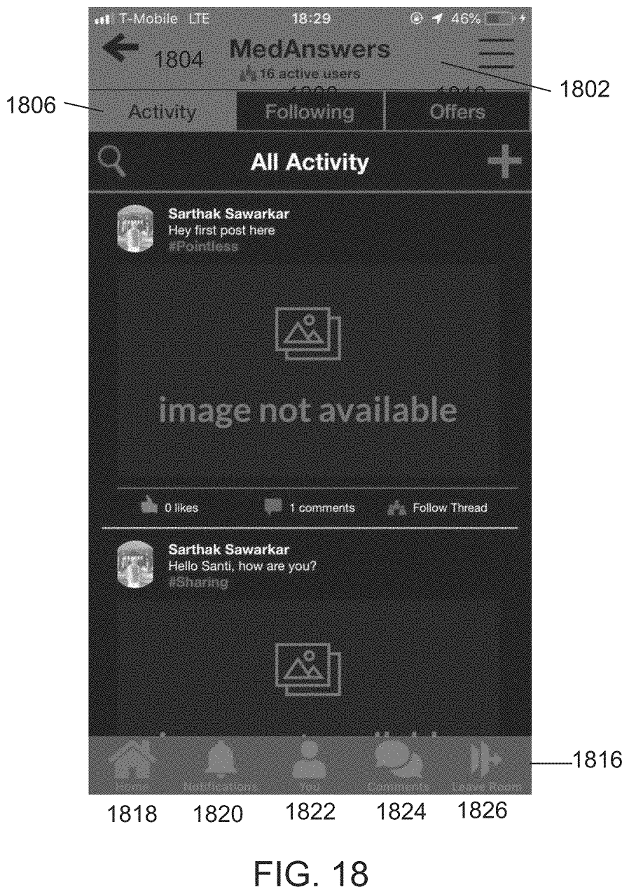

Shown in FIG. 18 is an example user interface displaying communication activity within the local communication network. The name of the communication network can be displayed at the top of the window at 1802—“MedAnswers.” In some examples, the display will include a listing of active users at 1804. The upper portion of the screen can also include options for navigating between content. For example, the user can select activity at 1806, following at 1808, and offers at 1810.

According to one embodiment, activity information within the communication network is shown by default as an initial view. The activity information can include an ordered list of posts and/or images from users participating in the communication network. For example, the first post can be displayed at 1812 and an older post displayed at 1814. In some embodiments, the system can order the display of such messages based on popularity, timeliness, or other criteria. Shown in 1816 is a series of additional navigation options, which allow the user to access information on the system. For example, the user can select home 1818 to return to a home screen similar to the display shown in FIG. 18. In another example, user may access notifications at 1820, information on their profile in 1822, any comments they have made in the communication network or any comments made about their posts in the communication network at 1824, and the user may exit the communication network by selecting leave room at 1826.

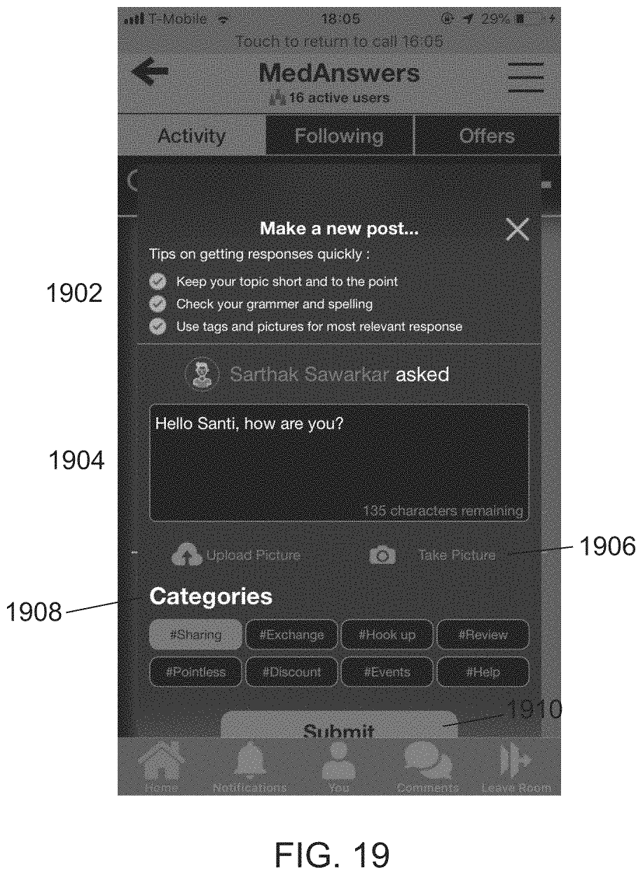

Shown in FIG. 19, is a user interface for creating a new post within a communication network. According to one embodiment, the user interface is configured to provide advice on creating good communications within the network. For example, shown at 1902 is a list of recommendations for good communication practices. At 1904 the user interface displays a text box for entering text to be displayed in a communication post. According to some embodiments, the user can upload an existing picture or take a picture at 1906. At 1908, the user may select categories to add to a post to facilitate communication. Once completed, the user can submit the communication to the network at 1910.

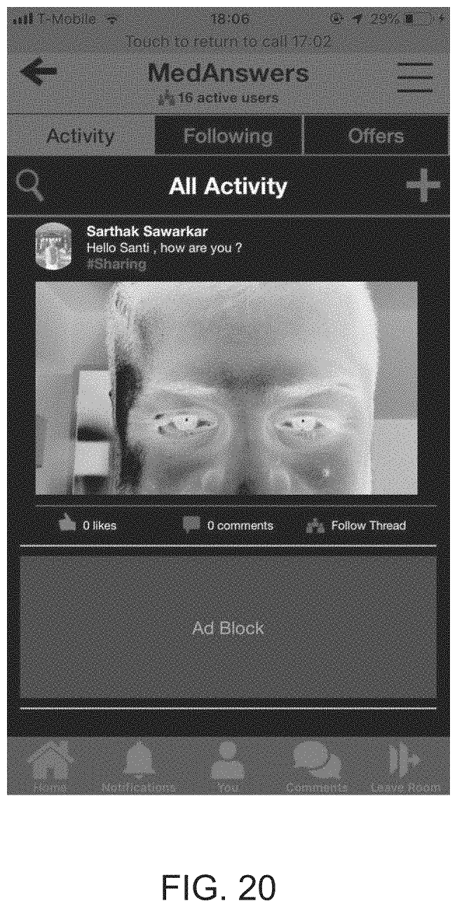

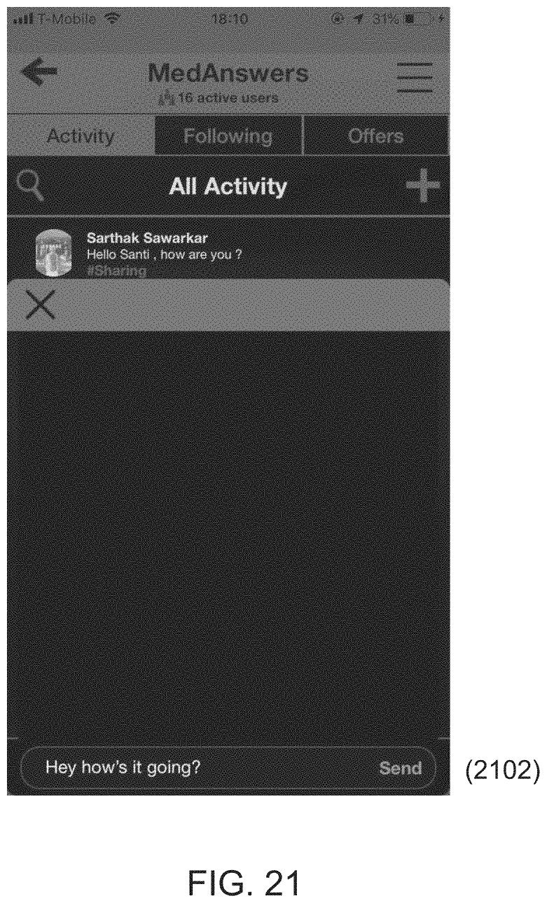

Shown in FIG. 20 is another example user interface which includes functionality for the system to identify and insert local offers to users of the local communication network (e.g., which can be displayed as part of process 2400, described below). Shown in FIG. 21 is another example user interface which provides functionality for another user to respond to initial communications (e.g., at 2102).

According to various aspects, the local communication network architecture provides a local community of users the ability to collaborate and connect anonymously with people in their immediate vicinity. This is quite unlike conventional communication systems and architectures where users have no concept of locality and posts requiring local connections and proximity largely go ignored. According to another aspect, the communication system resolves issues with conventional communication and content delivery. For example, various conventional approaches fail to provide hyper local person to person communication, fail to provide time relevant user content, fail to provide anonymous connections between the local community, fail to provide curated experiences within such networks, and fail to provide hyper local collaboration on content delivered to the network, among other shortcomings. Various embodiments of the system resolve at least one of these issues and many resolve combinations of such issues and yet other embodiments can be configured to address all of those issues.

According to another aspect, the system can be configured to track activity in the local communication networks including time spent and/or migration patterns between communication networks. Various aspects of the tracked information can be used by the system to target communication to specific users and/or qualify users to receive such targeted communication. In one example, the target communication can include hyper-local offers displayed to users within a knockable location. In further examples, commercial entities can specify migration pattern, time spent, physical presence, etc., as requirements for access to the hyper-local offers or communications. In some settings, the entity can define the requirements and the system is configured to automatically deliver the hyper-local communication when the requirements are satisfied.

In some embodiments, the system can be configured to provide a dashboard or collections of analytics on demographic information for the user base. In various embodiments, commercial entities can identify requirements for local offers/communications based on activity observed is user behavior, user patterns, user activity, etc. Various interfaces can be displayed by the system to provide access to the users' demographic information, as well as interfaces to provide additional detail on any displayed analytics.

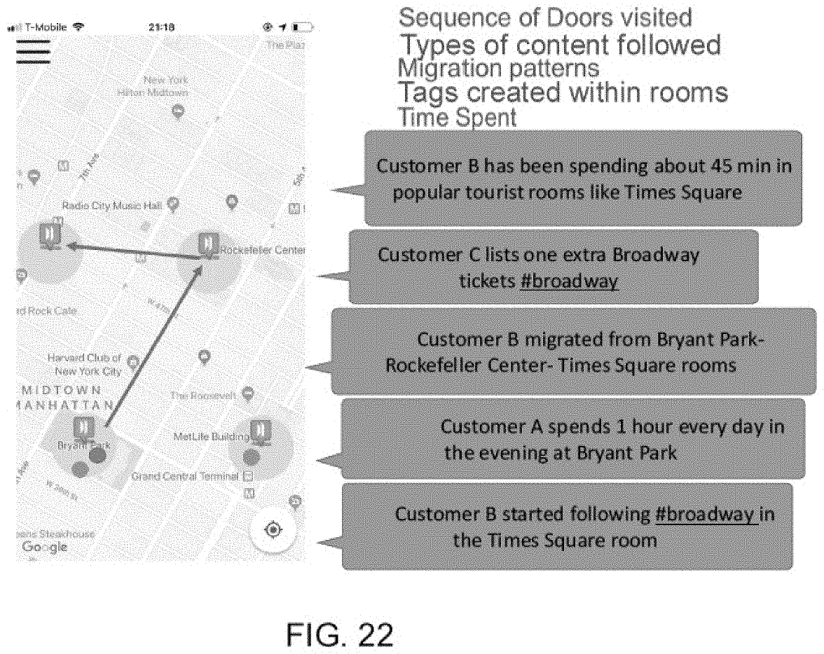

Shown in FIG. 22 is an example user interface and tract migration patterns for hypothetical user customer A, customer B, and customer C. As illustrated, the system can track information on the sequence of doors visited types of content followed, migration patterns, tags created with rooms, and time spent, amongst other examples. The tracked information allows the system to more accurately target various user behaviors, user patterns, and user interactions than conventional approaches. For example, the information collected (e.g. customer been spending approximately 45 minutes in popular tourist rooms (e.g., Times Square), customer C posts available tickets with tag Broadway, customer be migrated from Bryant Park to Rockefeller Center to Times Square, customer a spends approximately one hour every day in the evening at Bryant Park, in customer be followed the post Ted Bradley in the Times Square room. According to various embodiments, each of these behaviors can be specifically targeted with content and/or offers.

In further embodiments, the system can be configured to use the track data to optimize the communication networks being built and maintained. For example, data on the sequence of rooms visited, frequency of rooms visited, types of posts made, type of post followed, and usage times and locations, enables the system to optimize the sizing of the communication network (e.g. room size and location), as well as improve the targeting of content delivered within the communication network.

According to one aspect, the localized communication network architecture enables more accurate targeting, guarantees proximity, and provides options unavailable on conventional platforms for delivering content to user communities. The content delivery can be highly localized, temporal, and in some examples, reach into other communication networks based on connections between the users and/or migration patterns detected on the system.

According to another aspect, content delivery can include targeted advertising provided with highly localized features and content that leverage the bounded nature of the communication network architecture. For example, content is targeted and displayed deliberately for each user and in each setting. In one example, content may require collaborative redemption within the user community. Importantly various embodiments, limit the intrusive nature of content delivery such that delivered content will not annoy the target or distract from ongoing activity. In further embodiments, content is delivered responsive to determining that a user is in or near to a location for that content. Content delivery can be dynamic, in that the delivered content can be temporally and/or proximity limited. In other embodiments, the user community decides when to engage with the delivered content and limits the negative impact of such content.

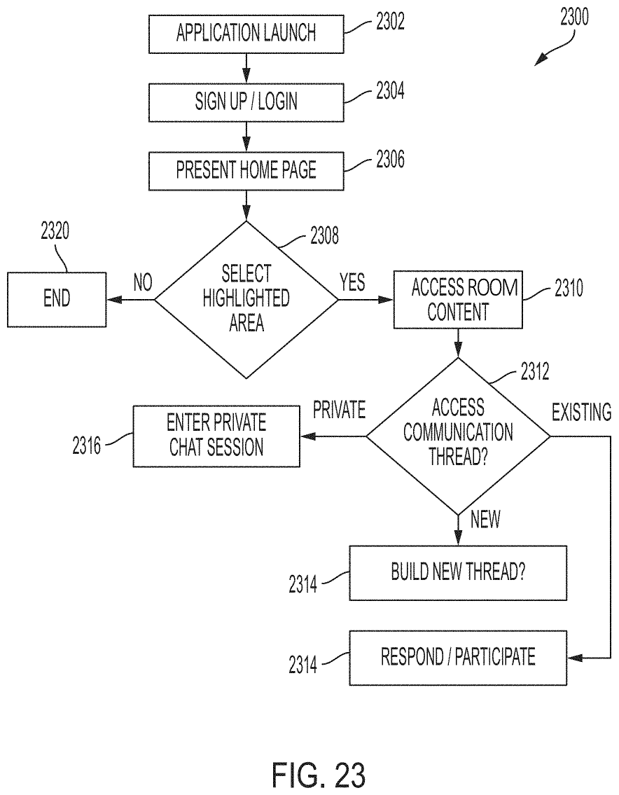

Shown in FIG. 23, is an example process flow 2300 for accessing and communicating within a localized network. According to one embodiment, process 2300 begins at 2302 with an application launch on a user device. At 2304, the user can sign up or login. The 2306, the system presents a homepage tailored to the individual user. The homepage display can include visualization of proximate locations (e.g. local networks) that the user can access. If the user selects a highlighted area at 2308 YES, the application provides access to the selected room and content at 2310. In some embodiments, the room can include access restrictions or permission requirements. If enabled, the user must satisfy any access requirement. If the user does not select the highlighted area, process 2300 ends at 2320.

Once the user enters a room (e.g. 2310), the user can access any displayed communication thread at 2312. For existing communication threads, the user can respond or participate in the communication thread at 2314. According to one alternative, any user can create a new communication thread at 2314. For example, the user can build a new communication thread and/or specify target users with whom to communicate.

In another alternative, users can create a private communication thread and enter a private chat session at 2316. According to some embodiments, process 2300 can include operations to enter existing communication threads, build new communication threads, and/or create private communication threads, among other options. Not shown in process 2300, the user application can also display hyper local communications created by external entities. The external entities are not necessarily participants in the local network or a knockable location.

However, the system provides functionality for external entities to create hyper local communications to the user populations of respective networks. In one embodiment, the system permits commercial entities to build hyper local offers responsive to the users qualifying for access to the hyper local offers.

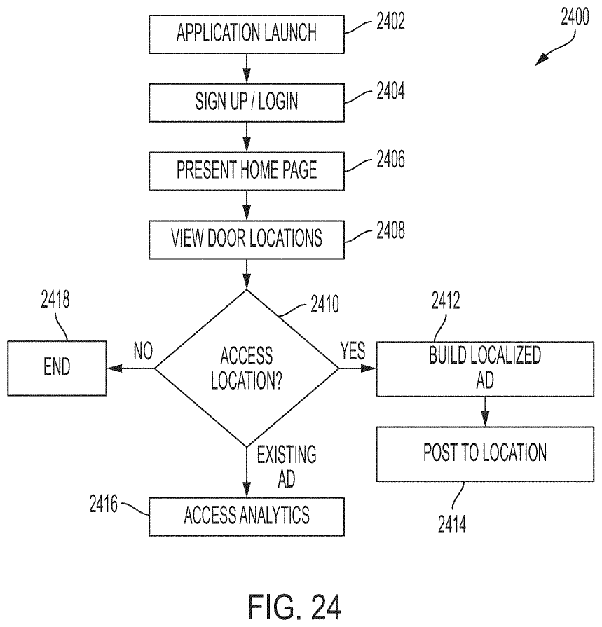

FIG. 24 illustrates an example process flow for creating a hyper local offers. According to one embodiment, process 2400 begins at 2402 with application lunch. The application requires sign up or log in at 2404. Once logged in, a homepage is presented at 2406. When creating hyper local offers the homepage that is presented at 2406 is tailored to building hyper local offers. For example, available door locations are displayed at 2408, and the entity can access the displayed locations at 2410. In another example, at 2410 YES the entity is given access to functionality to build localized communications at 2412 (e.g. advertisements). Once the entity specifies the details of the localized communication and any access requirements, process 2400 continues with posting the communication to the location. In various embodiments, the system manages the actual display of the localized communication. For example, the system determines if a user qualifies or meets any specified requirements for seeing the localized communication. In response to determining that a user meets the requirements the system will display the localized communication to that user.

Returning to 2410, access to an existing localized communication within a location provides access to analytic information regarding the localized communication at 2416. If at 2410, the entity does not access any locations the process can and at 2418.

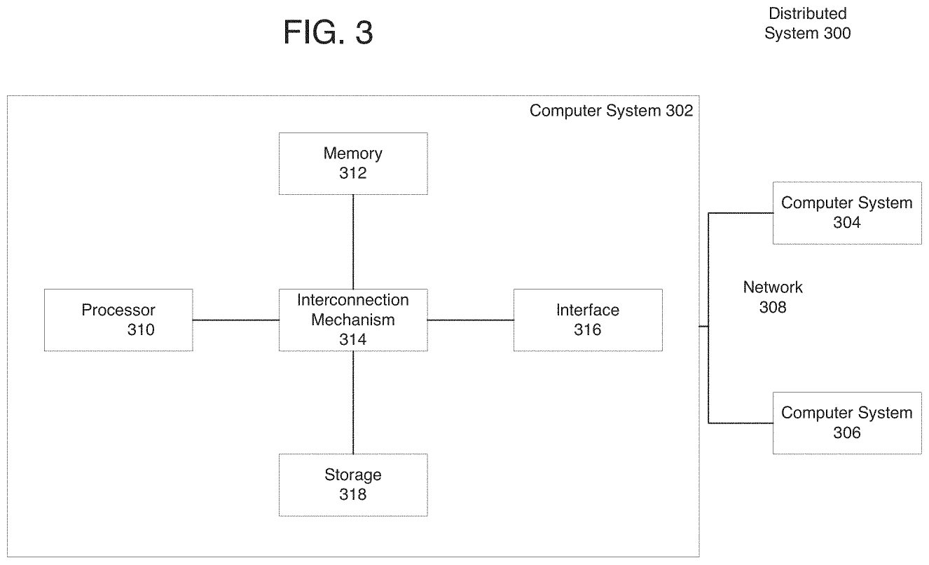

Referring to FIG. 3, there is illustrated a block diagram of a specially configured distributed computer system 300, in which various aspects and functions are practiced based on the unconventional implementation, algorithms, and functionality discussed herein. As shown, the distributed computer system 300 includes one or more computer systems that exchange information. More specifically, the distributed computer system 300 includes computer systems 302, 304, and 306. As shown, the computer systems 302, 304, and 306 are interconnected by, and may exchange data through, a communication network 308. The network 308 may include any communication network through which computer systems may exchange data. To exchange data using the network 308, the computer systems 302, 304, and 306 and the network 308 may use various methods, protocols and standards, including, among others, Fiber Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST, and Web Services. To ensure data transfer is secure, the computer systems 302, 304, and 306 may transmit data via the network 308 using a variety of security measures including, for example, SSL or VPN technologies. While the distributed computer system 300 illustrates three networked computer systems, the distributed computer system 300 is not so limited and may include any number of computer systems and computing devices, networked using any medium and communication protocol.

As illustrated in FIG. 3, the computer system 302 includes a processor 310, a memory 312, an interconnection element 314, an interface 316 and data storage element 318. To implement at least some of the aspects, functions, and processes disclosed herein, the processor 310 performs a series of instructions that result in manipulated data. The processor 310 may be any type of processor, multiprocessor or controller. Example processors may include a commercially available processor such as an Intel Xeon, Itanium, Core, Celeron, or Pentium processor; an AMD Opteron processor; an Apple A10 or A5 processor; a Sun UltraSPARC processor; an IBM Power5+ processor; an IBM mainframe chip; or a quantum computer. The processor 310 is connected to other system components, including one or more memory devices 312, by the interconnection element 314.

The memory 312 stores programs (e.g., sequences of instructions coded to be executable by the processor 310) and data during operation of the computer system 302. Thus, the memory 312 may be a relatively high performance, volatile, random access memory such as a dynamic random access memory (“DRAM”) or static memory (“SRAM”). However, the memory 312 may include any device for storing data, such as a disk drive or other nonvolatile storage device. Various examples may organize the memory 312 into particularized and, in some cases, unique structures to perform the functions disclosed herein. These data structures may be sized and organized to store values for particular data and types of data.

Components of the computer system 302 are coupled by an interconnection element such as the interconnection mechanism 314. The interconnection element 314 may include any communication coupling between system components such as one or more physical busses in conformance with specialized or standard computing bus technologies such as IDE, SCSI, PCI and InfiniBand. The interconnection element 314 enables communications, including instructions and data, to be exchanged between system components of the computer system 302.

The computer system 302 also includes one or more interface devices 316 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 302 to exchange information and to communicate with external entities, such as users and other systems.

The data storage element 318 includes a computer readable and writeable nonvolatile, or non-transitory, data storage medium in which instructions are stored that define a program or other object that is executed by the processor 310. The data storage element 318 also may include information that is recorded, on or in, the medium, and that is processed by the processor 310 during execution of the program. More specifically, the information may be stored in one or more data structures specifically configured to conserve storage space or increase data exchange performance. The instructions may be persistently stored as encoded signals, and the instructions may cause the processor 310 to perform any of the functions described herein. The medium may, for example, be optical disk, magnetic disk or flash memory, among others. In operation, the processor 310 or some other controller causes data to be read from the nonvolatile recording medium into another memory, such as the memory 312, that allows for faster access to the information by the processor 310 than does the storage medium included in the data storage element 318. The memory may be located in the data storage element 318 or in the memory 312, however, the processor 310 manipulates the data within the memory, and then copies the data to the storage medium associated with the data storage element 318 after processing is completed. A variety of components may manage data movement between the storage medium and other memory elements and examples are not limited to particular data management components. Further, examples are not limited to a particular memory system or data storage system.

Although the computer system 302 is shown by way of example as one type of computer system upon which various aspects and functions may be practiced, aspects and functions are not limited to being implemented on the computer system 302 as shown in FIG. 3. Various aspects and functions may be practiced on one or more computers having a different architectures or components than that shown in FIG. 3. For instance, the computer system 302 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 302 may be a computer system including an operating system that manages at least a portion of the hardware elements included in the computer system 302. In some examples, a processor or controller, such as the processor 310, executes an operating system. Examples of a particular operating system that may be executed include a Windows-based operating system, such as, Windows NT, Windows 2000 (Windows ME), Windows XP, Windows Vista or Windows 7, 8, or 3 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Oracle Corporation, or a UNIX operating systems available from various sources. Many other operating systems may be used, and examples are not limited to any particular operating system.

The processor 310 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C # (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

Based on the foregoing disclosure, it should be apparent to one of ordinary skill in the art that the embodiments disclosed herein are not limited to a particular computer system platform, processor, operating system, network, or communication protocol. Also, it should be apparent that the embodiments disclosed herein are not limited to a specific architecture or programming language.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Use of at least one of and a list of elements (e.g., A, B, C) is intended to cover any one selection from A, B, C (e.g., A), any two selections from A, B, C (e.g., A and B), any three selections (e.g., A, B, C), etc., and any multiples of each selection.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A communication system for managing hyper-local communication boundaries and associated communications, the system comprising:
at least one processor operatively connected to a memory;
a positioning component, executed by the at least one processor, configured to establish positioning for a communication device associated with a user;
a network boundary component, executed by the at least one processor, configured to define a plurality of communication boundaries having a respective physical location for respective ones of a plurality of communication networks;
a communication controller component, executed by the at least one processor, configured to:
establish an association between a device location and at least a respective one of the plurality of communication boundaries;
permit access to a hyper-local communication network responsive to a determining a communication device is within or proximate to the respective one of the plurality of communication boundaries; and
prevent access to the hyper-local communication network responsive to determining the communication device is outside of or not proximate to the respective one of the plurality of communication boundaries.

2. The system of claim 1, further comprising a dynamic communication interface configured to display a user interface on a respective device, wherein the UI dynamically adjusts communication functions and displays based on permitted access to respective ones of the hyper-local communication networks.

3. The system of claim 1, wherein the network boundary component is further configured to establish a respective physical boundary for a communication network based on a location of a venue or institution.

4. The system of claim 3, wherein the network boundary component is further configured to establish a temporary network and associated the temporary network with a virtual location associated with a physical location and future event to take place at the physical location.

5. The system of claim 1, wherein the network boundary component is further configured to establish a new communication network dynamically, responsive to a user request and user definition of a communication boundary.

6. The system of claim 1, further comprising a validation component, executed by the at least one processor, configured to validate users for access to the hyper-local communication network.

7. The system of claim 1, wherein the communication boundaries include at least one static boundary defining a first hyper-local network and at least one dynamically generated communication boundary defining a second hyper-local network.

8. A computer implemented method for managing local communication boundaries and associated networks, the method comprising:
establishing, by at least one processor, positioning for a communication device associated with a user;
defining, by the at least one processor, a plurality of communication boundaries having a respective physical location for respective ones of a plurality of communication networks;
generating, by the at least one processor, an association between a device location and at least a respective one of the plurality of communication boundaries;
permitting, by the at least one processor, access to a localize communication network responsive to a determining a communication device is within or proximate to the respective one of the plurality of communication boundaries; and
preventing, by the at least one processor, access to the local communication network responsive to determining the communication device is outside of or not proximate to the respective one of the plurality of communication boundaries.

9. The method of claim 8, further comprising to displaying a user interface on a respective device, wherein the UI is configured to dynamically adjust communication functions and displays based on permitted access to respective ones of the hyper-local communication networks.

10. The method of claim 8, wherein the method further comprises establishing a respective physical boundary for a respective communication network based on a location of a venue or institution.

11. The method of claim 10, wherein the method further comprises establishing a temporary network and associated the temporary network with a virtual location and future event.

12. The method of claim 8, wherein the method further comprises establishing a new communication network dynamically, responsive to a user request.

13. The method of claim 1, wherein the method further comprises validating users for access to a respective local communication network.

14. The method of claim 1, wherein the method further comprises defining a first local network with a static communication boundary and at least one dynamically generated communication boundary defining a second local network.

15. A non-transitory computer readable medium containing instructions that when executed cause at least one processor to execute a computer implemented method for managing local communication boundaries and associated networks, the method comprising:
establishing positioning for a communication device associated with a user;
defining a plurality of communication boundaries having a respective physical location for respective ones of a plurality of communication networks;
generating an association between a device location and at least a respective one of the plurality of communication boundaries;
permitting access to a localize communication network responsive to a determining a communication device is within or proximate to the respective one of the plurality of communication boundaries; and
preventing access to the local communication network responsive to determining the communication device is outside of or not proximate to the respective one of the plurality of communication boundaries.

16. The medium of claim 15, wherein the method further comprises displaying a user interface on a respective device, wherein the UI is configured to dynamically adjust communication functions and displays based on permitted access to respective ones of the hyper-local communication networks.

17. The medium of claim 15, wherein the method further comprises establishing a respective physical boundary for a respective communication network based on a location of a venue or institution.

18. The medium of claim 17, wherein the method further comprises establishing a temporary network and associated the temporary network with a virtual location and future event.

19. The medium of claim 15, wherein the method further comprises establishing a new communication network dynamically, responsive to a user request.

20. The medium of claim 19, wherein the method further comprises validating users for access to a respective local communication network.
